(19) United States
(12) Patent Application Publication
(10) Pub. No.: US 2009/0108151 A1
(43) Pub. Date: Apr. 30, 2009

(54) Transparent suction cup mounting platform

(76) Inventor: Jeffrey D. Carnevali, Seattle, WA (US)

Correspondence Address: CHARLES J RUPNICK, PO BOX 46752, SEATTLE, WA, 98146, US

(21) Appl. No.: 12/009,551

(22) Filed: Jan. 17, 2008

Related U.S. Application Data
(63) Continuation-in-part of application No. 11/977,812, filed on Oct. 26, 2007.
Application No. 11/977,812 is a continuation-in-part of application No. 12/006,386, filed on Jan. 2, 2008.

(51) Int. Cl. F16B 47/00

(52) U.S. Cl. 248/205.3; 248/205.5

(57) ABSTRACT

A monolithic suction cup mounting platform formed of a substantially optically transparent rigid plate having first and second opposing faces; a suction cup mounting surface is formed on the first face of the plate; a bonding surface is formed on the second face of the plate; and a substantially optically transparent bonding agent is adhered to the bonding surface of the second face of the plate.

This application is a Continuation-in-part and claims priority benefit of copending parent U.S. patent application Ser. No. 11/977,812 filed in the name of Jeffrey D. Carnevali on Oct. 26, 2007, and copending parent U.S. patent application Ser. No. 12/006,386 filed in the name of Jeffrey D. Carnevali on Jan. 2, 2008, the complete disclosures of which are both incorporated herein by reference.

### FIELD OF THE INVENTION

The present invention relates generally to mounting platforms for attachment of suction cups, and in particular to suction cup mounting platforms having transparent features for viewing target attachment surfaces therethrough.

### BACKGROUND OF THE INVENTION

Suction cup mounting devices are generally well-known for mounting various handheld electronic devices for hands-free operation, particularly in automobiles and other vehicles. However, the only smooth and flat surface available for mounting suction cups in many vehicles are the front or side windscreens. As a result, suction cup mounting devices are being replaced by custom vehicle specific mounts (VSM) for installing a wide range of handheld devices in cars, trucks, vans and sport utility vehicles (SUV's). Such VSM's are designed by various US manufacturers to blend into the vehicle's interior with a professional fit and factory-like appearance. Such VSM's are designed to use existing dash fittings behind the trim so that alterations to the vehicle's interior are eliminated. They are ergonomically designed for hands-free operation so the driver can keep eyes on the road, while positioning the electronic device within easy reach and operation. Such VSM's are custom designed for nearly every popular vehicle on the road.

VSM's feature a standard AMPS hole pattern for mounting cradles designed for popular handheld accessories, e.g., XM Satellite radios, holders, phone and personal digital assistant (PDA) or iPod interfaces, et cetera. They feature optimum vehicle mounting location so as to maximize safety for both the driver and the passengers. When properly installed VSM's are virtually unseen. They have no movable parts and custom bends so that no adjustments are required to perfect installation. Additionally, they install easily behind the dash bezel, often using existing original hardware, but they do not block airbags, nor obstruct dash amenities or controls. VSM's provide a rock solid mounting platform for the most popular handheld accessories.

However, known VSM's are limited precisely because they feature the standard AMPS hole pattern, which is a common hole pattern adopted by most electronics manufacturers for mounting their devices. Such hole patterns in their ability to provide a quick and easy way to move the handheld mount between vehicles since it must be connected to the AMPS hole pattern with fasteners.

Furthermore, known apparatuses having smooth and flat surface available for mounting suction cups are invariably opaque such as to occlude viewing of the target attachment surface, whether the dash or console interior surface of the vehicle, such as to be unsightly. Such opaque suction cup mounting platforms further partially obstruct viewing through a vehicle front or side windscreen when attached to same, thereby causing a safety hazard.

### SUMMARY OF THE INVENTION

The present invention is a novel transparent suction cup mounting platform that is virtually invisible so as not to occlude viewing of the target attachment surface, nor to obstruct viewing when attached to windscreen surfaces.

According to one aspect of the invention the novel suction cup mounting platform is a simple plate structured of a substantially optically transparent rigid material and having first and second opposing faces. A suction cup mounting surface is formed on the first face of the plate; and a bonding surface is formed on the second face of the plate. A substantially optically transparent bonding agent is adhered to the bonding surface of the second face of the plate.

According to another aspect of the invention, the bonding agent is a pressure sensitive adhesive adhered to the bonding surface of the second face of the plate.

According to another aspect of the invention, a carrier film is adhered to the bonding surface of the second face of the plate. The carrier film includes the pressure sensitive adhesive provided on a surface thereof opposite from the bonding surface. Furthermore, the carrier film is formed of a substantially optically transparent material.

According to another aspect of the invention, a pressure sensitive adhesive is bonded between the carrier film and the bonding surface.

According to another aspect of the invention, the second face of the plate is further formed with a recess therein, the recess having the bonding surface formed therein, and the carrier film is adhered to the bonding surface in such manner that it projects from the recess outwardly of the second face of the plate.

According to another aspect of the invention, the material of the plate is further substantially homogeneous in consistency.

According to another aspect of the invention, the material of the carrier film is further substantially homogeneous in consistency.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing an operational example of the present invention illustrated by example and without limitation as a novel suction cup mounting platform formed as a substantially rigid monolithic mounting plate having a suction cup mounting device mounted on a suction cup mounting surface thereof, the novel suction cup mounting platform is illustrated here by example and without limitation as being attached to a accessory vehicle mounting platform by fastening means and mounted within an interior space of a vehicle;

FIG. 2 is a top perspective view that illustrates the novel suction cup mounting platform by example and without limitation as being formed of the substantially rigid monolithic mounting plate formed of an injection moldable material, such as plastic, having a first face thereof being formed with the substantially smooth and planar surface of a type useful as a suction cup mounting surface;

FIG. 3 illustrates a second face of the substantially rigid monolithic mounting plate of the novel suction cup mounting platform as including by example and without limitation the fastening means as being compatible for fastening to a first predetermined hole pattern, for example a standard AMPS hole pattern;

FIG. 4 illustrates the monolithic mounting plate of the novel suction cup mounting platform being attached to the accessory vehicle mounting platform by the fastening means;

FIG. 5 illustrates the monolithic mounting plate of the novel suction cup mounting platform being attached to the accessory vehicle mounting platform in such manner that the suction cup mounting surface formed on the first face thereof is facing away therefrom and being substantially fully exposed for attachment thereto of the suction cup mounting devices;

FIG. 6 is a perspective view showing an operational example of the novel suction cup mounting platform by example and without limitation as being attached to a weighted mounting platform and mounted within an interior space of a vehicle;

FIG. 7 illustrates the novel suction cup mounting platform being attached to the weighted mounting platform with the suction cup mounting device being removed for clarity from the suction cup mounting surface portion of the first face of the mounting plate, as by release of the suction holding it thereto;

FIG. 8 illustrates the novel suction cup mounting platform being attached to the weighted mounting platform having the common central hub thereof being formed with a hole pattern through a base portion thereof, such as the standard AMPS hole pattern;

FIG. 9 is a cross-section view that illustrates by example and without limitation the novel suction cup mounting platform being attached to the weighted mounting platform as discussed herein;

FIG. 10 is another cross-section view that illustrates by example and without limitation the novel suction cup mounting platform being attached to the weighted mounting platform as discussed herein;

FIG. 11 is a perspective view showing an operational example of the novel suction cup mounting platform by example and without limitation as being attached to an interlockable ball-and-socket type swivel mount assembly and mounted within an interior space of a vehicle;

FIG. 12 is another perspective view showing an operational example of the novel suction cup mounting platform by example and without limitation as being attached to an interlockable ball-and-socket type swivel mount assembly and mounted within an interior space of a vehicle;

FIG. 13 illustrates the novel suction cup mounting platform being attached to either of the accessory vehicle mounting platform or directly to an interior surface of the vehicle, such as the dash or a console utilizing a Pressure Sensitive Adhesive or PSA fastening means;

FIGS. 14, 15 and 16 show the present invention illustrated by example and without limitation as an alternative suction cup mounting platform formed as a substantially transparent platform having a substantially transparent pressure sensitive adhesive (PSA) adhered to a bonding surface thereof facing away from the mounting plate, wherein FIG. 14 is a top perspective assembly view featuring the mounting plate, FIG. 15 is a side assembly view, and FIG. 16 is bottom perspective assembly view;

FIG. 17 is a bottom perspective view showing the substantially transparent suction cup mounting platform assembly in cross-section;

FIG. 18 is a side cross-section view showing the substantially transparent suction cup mounting plate portion of the platform assembly;

FIG. 19 is a bottom perspective cross-section view showing the substantially transparent suction cup mounting plate portion of the platform assembly;

FIG. 20 is a top perspective view that illustrates the alternative substantially transparent suction cup mounting platform assembly in operation having a suction cup mounting device mounted thereon;

FIG. 21 is a bottom perspective view that illustrates the alternative substantially transparent suction cup mounting platform assembly in operation having a suction cup mounting device mounted thereon; and

FIGS. 22 and 23 illustrate the transparency of the alternative substantially transparent suction cup mounting platform assembly, wherein FIG. 22 is a top perspective view, and FIG. 23 is a bottom perspective view.

### DETAILED DESCRIPTION OF PREFERRED EMBODIMENT

In the Figures, like numerals indicate like elements.

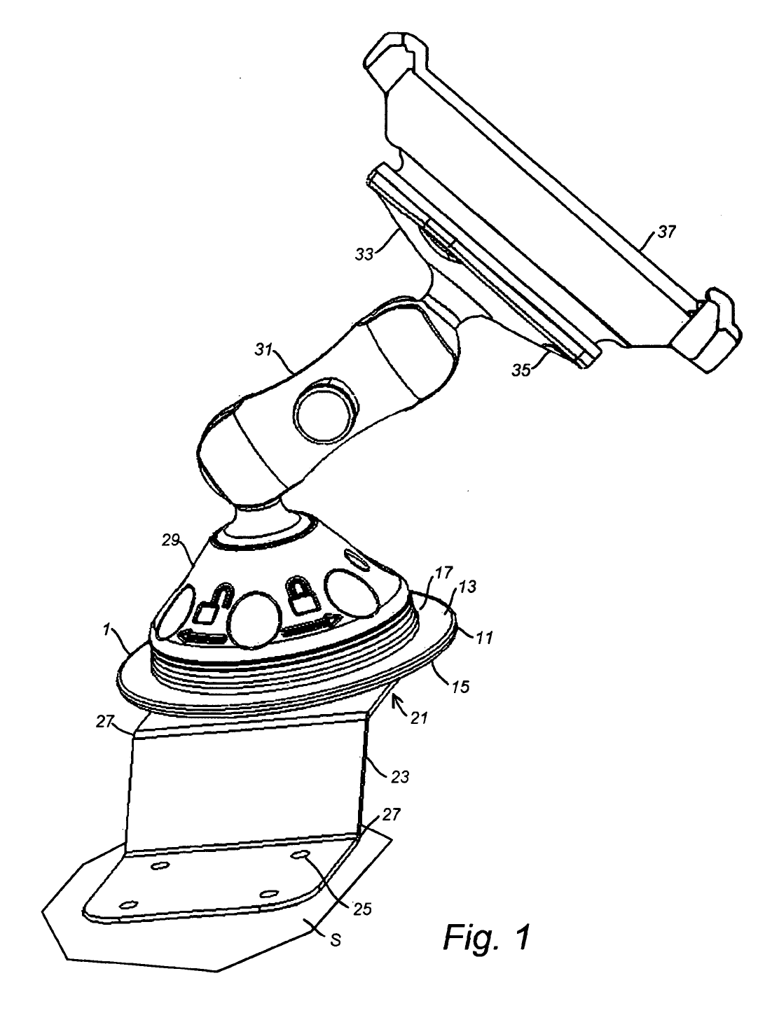

FIG. 1 shows the present invention illustrated by example and without limitation as a suction cup mounting platform 1 formed as a substantially rigid monolithic mounting plate 11 having first and second opposing faces 13 and 15. The first face 13 is formed with a substantially smooth and planar surface 17 of a type useful as a suction cup mounting surface. As illustrated in one or more subsequent Figures, the second face 15 includes a fastening means 19 for fastening to a first predetermined hole pattern 21, for example a standard AMPS hole pattern, which is a common hole pattern adopted by most electronics manufacturers for mounting cradles designed for their handheld electronics accessories. The fastening means 19 is thus compatible with the first predetermined standard AMPS hole pattern 21.

The fastening means 19 is utilized for fastening the mounting plate 11 to an accessory vehicle mounting platform 23 structured for installing a wide range of handheld devices in cars, trucks, vans and sport utility vehicles (SUV's), as is well-known in the art. The vehicle mounting platform 23 is formed with the predetermined hole pattern 21. Here, the accessory vehicle mounting platform 23 is further formed with a second predetermined hole pattern 25 designed to use existing dash fittings behind the trim so that alterations to the vehicle's interior surfaces are eliminated, as is also well-known in the art. The second predetermined hole pattern 25 is spaced away from the first predetermined hole pattern 21 so that the suction cup mounting platform 1 mounted thereon is substantially clear of the dash, including airbags, dash amenities and controls. The accessory vehicle mounting platform 23 is further formed with one or more custom bends 27 so that no adjustments are required to perfect installation in the vehicle. Additionally, the custom bends 27 permit the accessory vehicle mounting platform 23 to be installed easily behind the dash bezel, often using existing original hardware with the second predetermined hole pattern 25, but without blocking airbags, nor obstructing dash amenities or controls. Such accessory vehicle mounting platform 23 thus provide a rock solid mounting platform for mounting cradles to hold the most popular handheld electronics accessories.

Obviously, the first standard AMPS or other hole pattern 21 for mounting cradles for handheld electronics accessories prevents a suction cup device from drawing a vacuum. Therefore, known accessory vehicle mounting platforms 23 are limited to having such accessory cradles permanently secured using mechanical fasteners.

In contrast to known accessory vehicle mounting platforms 23, according to the present invention, after the accessory vehicle mounting platform 23 is installed within the interior of the vehicle, a suction cup mounting device 29 is mounted on the suction cup mounting surface 17 formed on the first face 13 of the mounting plate 11. Such suction cup mounting devices 29 include, but are not limited to, suction cup mounting devices of the type disclosed by the inventor of the present invention in U.S. Pat. No. 6,666,420, “Suction Cup Having Compact Axial Installation And Release Mechanism” issued Dec. 23, 2003, which is incorporated in its entirety herein by reference.

The suction cup mounting device 29 is illustrated here as having a dual ball-and-socket coupler 31, for example, of the well-known type disclosed by the inventor of the present invention in U.S. Pat. No. 5,845,885, “Universally Positionable Mounting Device” issued Dec. 8, 1998, which is incorporated in its entirety herein by reference. The coupler 31 supports another mounting platform 33 having a predetermined hole pattern 35, either a duplicate of the first predetermined standard AMPS hole pattern 21, or another hole pattern compatible with one or more mounting cradles 37 of types designed for receiving different handheld electronics accessories by different manufacturers. Else, the hole pattern 35 is a custom hole pattern compatible with one or more proprietary mounting cradles 37 of types designed for different handheld electronics accessories by a single manufacturer, such as the manufacturer of the present suction cup mounting platform 1. Accordingly, the present invention takes the accessory vehicle mounting platform 23 having the predetermined hole pattern 21 for attaching thereto one or more different mounting cradles 37 for receiving different handheld electronics accessories by different manufacturers and converts it into the suction cup mounting platform 1 having the suction cup mounting surface 17 formed on the first face 13 of the mounting plate 11. Thereafter, the user freely connects and disconnects the suction cup mounting devices 29 to the mounting surface 17 for holding a selected device mounting cradle 37 in a convenient location within the vehicle.

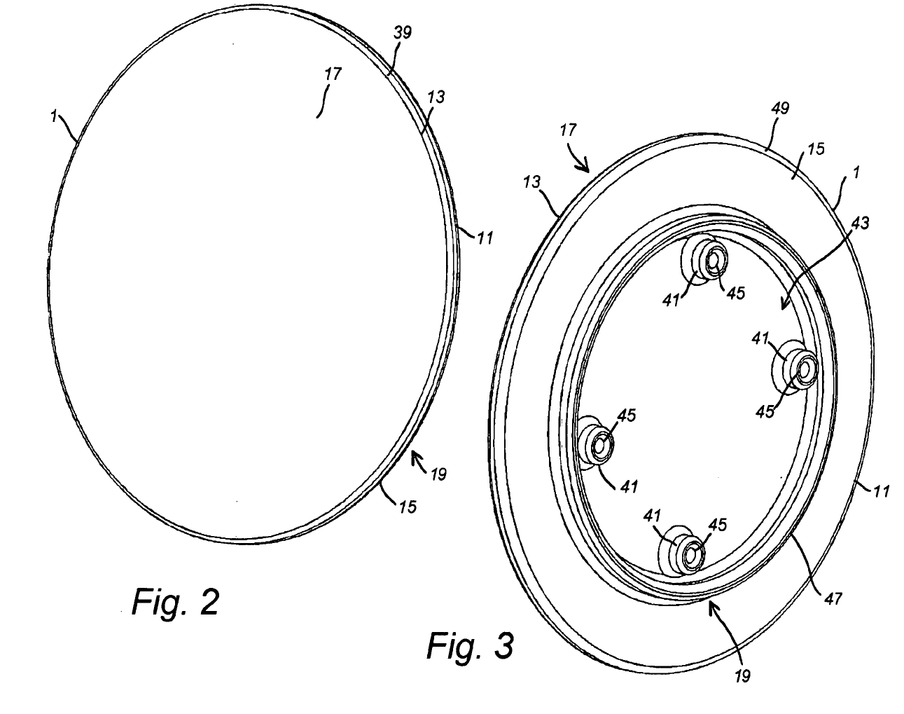

FIG. 2 illustrates the suction cup mounting platform 1 by example and without limitation as being formed of the substantially rigid monolithic mounting plate 11 formed of an injection moldable material, such as plastic, having the first face 13 thereof being formed with the substantially smooth and planar surface 17 of a type useful as a suction cup mounting surface. As illustrated here, the mounting plate 11 is optionally substantially round in shape having the suction cup mounting surface 17 covering substantially the entirety of the first face 13 thereof The face 13 having an optional peripheral edge break 39 to eliminate sharp edges. Alternatively, the suction cup mounting surface 17 covers a portion of the first face 13 less than substantially the entirety thereof The mounting plate 11 optionally may be another shape than substantially round; for example, the mounting plate 11 may be substantially square or polygonal without deviating from the scope and intent of the present invention.

FIG. 3 illustrates the second face 15 of the substantially rigid monolithic mounting plate 11, which by example and without limitation includes the fastening means 19 for fastening to the first predetermined hole pattern 21, for example the standard AMPS hole pattern. The fastening means 19 is thus compatible with the first predetermined standard AMPS hole pattern 21. Here, by example and without limitation, the fastening means 19 is provided as a plurality of bosses 41 raised on the second face 15, each of the bosses 41 being arranged in a pattern 43 that is compatible with the standard AMPS hole pattern used for the accessory vehicle mounting platform 23.

By example and without limitation, the bosses 41 are provided with a fastener receptor hole 45 substantially perpendicular to the second face 15, but that does not pierce the mounting plate 11. The receptor holes 45 are optionally formed with screw threads for receiving a threaded fastener, or are optionally smooth bore suitable for receiving a self-tapping screw fastener. Other fastening means 19 are also contemplated and may be substituted without deviating from the scope and intent of the present invention. For example, the fastening means 19 is optionally a plurality of threaded studs arranged in the pattern 43 that is compatible with the standard AMPS hole pattern 21 used for the accessory vehicle mounting platform 23.

Optionally, the second face 15 of the substantially rigid monolithic mounting plate 11 further includes a stiffener structure 47. By example and without limitation, the optional stiffener structure 47 is integrally formed with the monolithic mounting plate 11 as an intermittent or continuous (shown) substantially circular hoop or ridge spaced outboard of the bosses 41 but may be inboard of an outer peripheral edge break 49 of the second face 15, as illustrated here by example and without limitation. As illustrated here, the optional stiffener structure 47 also provides a mounting seat relative to the accessory vehicle mounting platform 23 by being projected away from the second face 15 of the mounting plate 11 farther than the bosses 41 of the fastening means 19. Accordingly, the optional stiffener structure 47, when present, engages the accessory vehicle mounting platform 23 in a ring outside of the fastening means 19 securing the mounting plate 11 thereto.

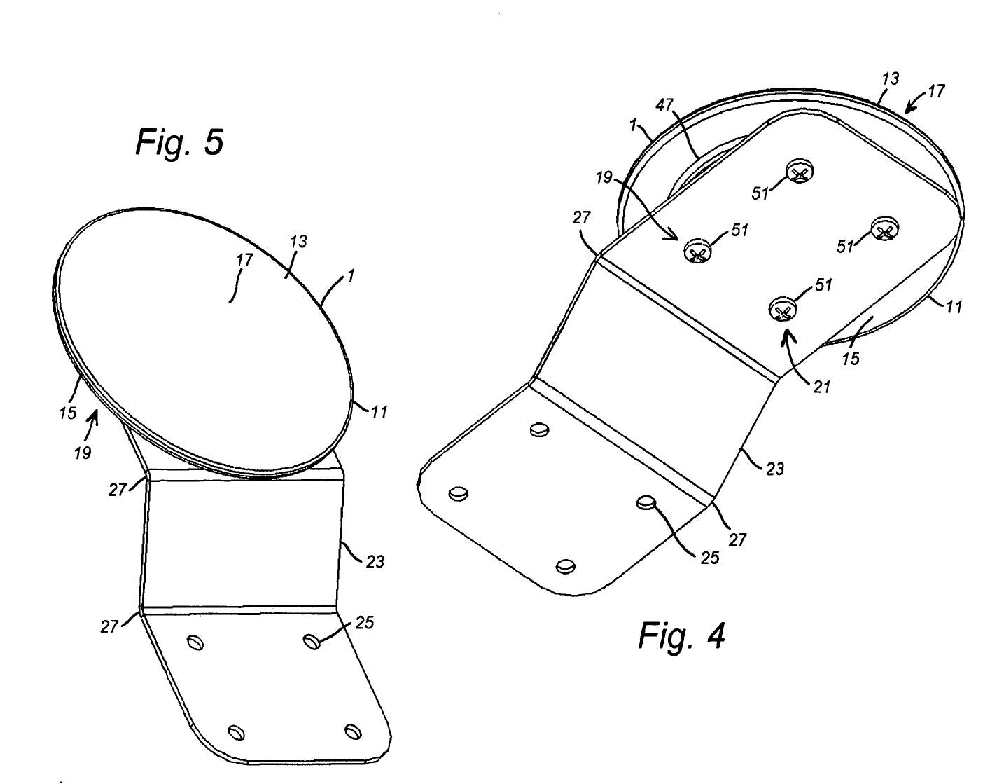

FIG. 4 illustrates the monolithic mounting plate 11 of the suction cup mounting platform 1 being attached to the accessory vehicle mounting platform 23 by the fastening means 19, which is illustrated here by example and without limitation as a plurality of screw-type fasteners 51 inserted through the first predetermined hole pattern 21 in the accessory vehicle mounting platform 23. As illustrated, the monolithic mounting plate 11 of the suction cup mounting platform 1 is sized relative to the accessory vehicle mounting platform 23 such that the second predetermined hole pattern 25 weighted mounting platform 53 using existing dash fittings behind the trim.

FIG. 5 illustrates the monolithic mounting plate 11 of the suction cup mounting platform 1 being attached to the accessory vehicle mounting platform 23 in such manner that the first face 13 is facing away therefrom with the suction cup mounting surface 17 formed thereon being substantially fully exposed for attachment thereto of the suction cup mounting devices 29.

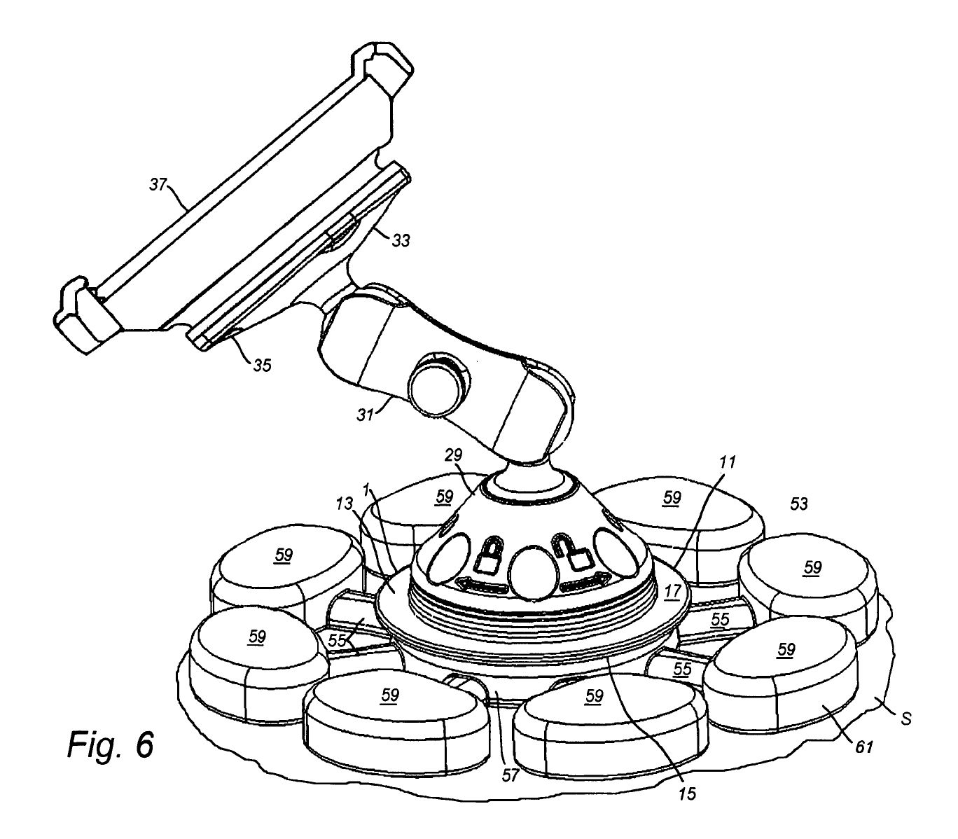

FIG. 6 illustrates the suction cup mounting platform 1 being attached to a weighted mounting platform 53, for example, of the type disclosed by the inventor of the present invention in U.S. Pat. No. 6,840,487, “Weighted Mounting Platform” issued Jan. 11, 2005, which is incorporated in its entirety herein by reference, or in U.S. patent application Ser. No. 11/975,575, “Method For Manufacturing A Weighted Base” filed in the name of the inventor of the present invention on Oct. 20, 2007, which is incorporated in its entirety herein by reference. Accordingly, the weighted mounting platform 53 is illustrated here as being of the type having a plurality of flexible legs 55 extending radially from a common central hub portion 57, each of the legs 55 having a heavy lump 59 at an end thereof distal from the common central hub 57. A sheath or coating 61 of soft elastomeric material is optionally formed over substantially the entire surface of the flexible legs 55 and the heavy lumps 59, and all or part of the common central hub 57. The monolithic mounting plate 11 of the suction cup mounting platform 1 being attached to the central hub 57 of the weighted mounting platform 53 in such manner that the flexible legs 55 with the heavy lumps 59 at the distal ends thereof are free to drape over an interior surface S of the vehicle, such as the dash or a console or passenger seat. The suction cup mounting platform 1 thus easily supports the suction cup mounting device 29 in an upright manner on the weighted mounting platform 53 with the suction cup mounting device 29 being coupled by suction to the substantially smooth and planar suction cup mounting surface 17 portion of the first face 13 of the mounting plate 11.

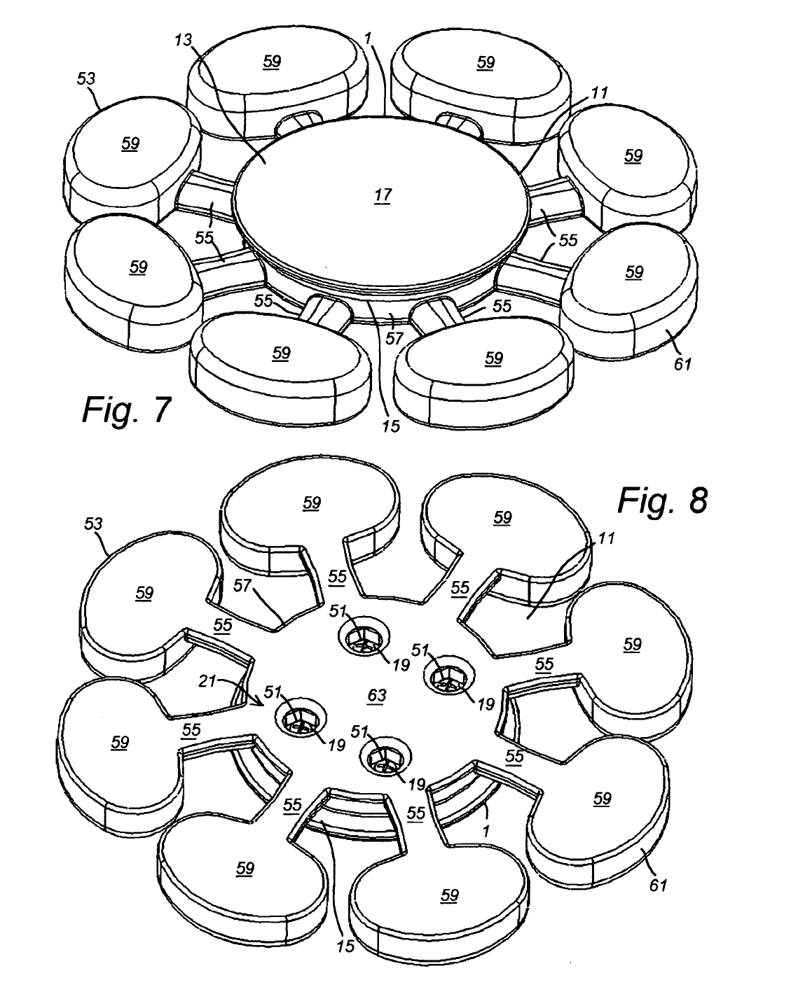

FIG. 7 illustrates the suction cup mounting platform 1 being attached to the weighted mounting platform 53 with the suction cup mounting device 29 being removed for clarity from the suction cup mounting surface 17 portion of the first face 13 of the mounting plate 11, as by release of the suction holding it thereto. As discussed herein, the monolithic mounting plate 11 of the suction cup mounting platform 1 is attached to the central hub 57 of the weighted mounting platform 53 in such manner that the flexible legs 55 with the heavy lumps 59 at the distal ends thereof are free to drape over an interior surface S of the vehicle, such as the dash or a console or passenger seat.

FIG. 8 illustrates the weighted mounting platform 53 with the common central hub 57 thereof being formed with a hole pattern through a base portion 63 thereof, such as the first predetermined standard AMPS hole pattern 21. Accordingly, the suction cup mounting platform 1 is attached to the weighted mounting platform 53 by the fastening means 19, which as discussed herein, is compatible with the first predetermined standard AMPS hole pattern 21.

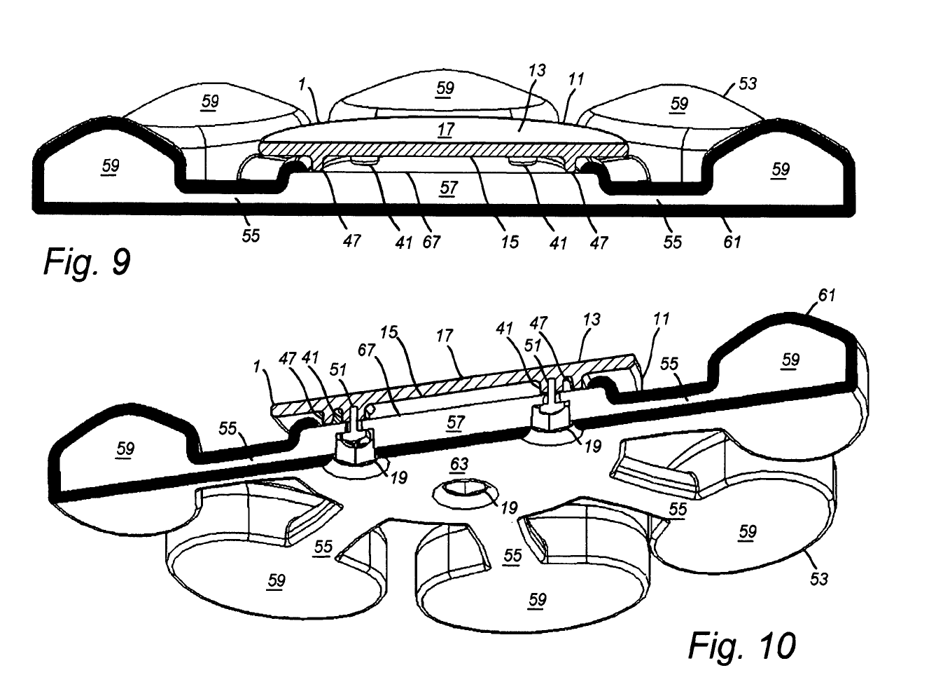

FIG. 9 illustrates the suction cup mounting platform 1 is attached to the weighted mounting platform 53 as discussed herein. The monolithic mounting plate 11 of the suction cup mounting platform 1 is shown herein cross-section, as is the weighted mounting platform 53. As can be seen here, the monolithic mounting plate 11 is structured to fit onto the central hub 57 of the weighted mounting platform 53 without interference with the flexible legs 55 nor with the heavy lumps 59 at the distal ends thereof. Furthermore, the optional stiffener structure 47 is integrally formed with the second face 15 of the monolithic mounting plate 11 to fit securely against the central hub 57 of the weighted mounting platform 53. The suction cup mounting platform 1 thus presents the first face 13 of the monolithic mounting plate 11 with the suction cup mounting surface 17 formed thereon being substantially fully exposed for attachment thereto of the suction cup mounting devices 29.

FIG. 10 is another cross-section view of both the weighted mounting platform 53 and the suction cup mounting platform 1 attached thereto. Here, the view is perspective from the base portion 63 of the common central hub 57. This view shows the monolithic mounting plate 11 being secured to the central hub 57 of the weighted mounting platform 53 by the fastening means 19, which as discussed herein, is either threaded screw fasteners received into the receptor holes 45, or threaded studs projected from the second face 15 of the mounting plate 11 and received into the standard AMPS hole pattern 21 used for the accessory vehicle mounting platform 23.

Here, the fastening means 19 is illustrated by example and without limitation as the plurality of screw-type fasteners 51 received into the receptor holes 45 in the bosses 41 projected from the second face 15 of the mounting plate 11. The plurality of screw fasteners 51 are either conventional screw fasteners received into threaded receptor holes 45, or self-tapping screw fasteners received into smooth bore receptor holes 45. Tightening the fastening means 19 snugs the optional integral stiffener structure 47 against a mounting surface 67 of the weighted mounting platform's central hub 57 outboard of the bosses 41, which prevents tipping of the mounting plate 11. After the weighted mounting platform 53 is installed within the interior of the vehicle, the suction cup mounting device 29 is mounted on the suction cup mounting surface 17 formed on the first face 13 of the mounting plate 11, as illustrated herein.

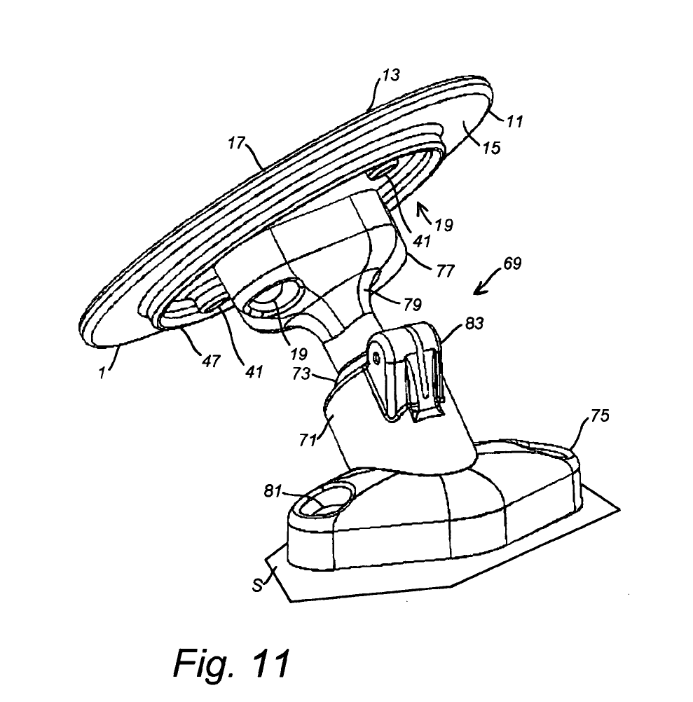

FIG. 11 illustrates the suction cup mounting platform 1 being attached to an interlockable ball-and-socket type swivel mount assembly 69, for example, of the type disclosed by the inventor of the present invention in U.S. Pat. No. 6,561,476, “Positively-Positionable Mounting Apparatus” issued May 13, 2003, which is incorporated in its entirety herein by reference. The swivel mount assembly 69 includes a fixed portion 71 of a ball-and-socket type swivel 73 projected from a first mounting base 75. The swivel mount assembly 69 also includes a second mounting base 77 projected from a swivel portion 79 of the ball-and-socket type swivel 73. One or more fasteners 81 secure the first mounting base 75 to the interior surface S of the vehicle. The fastening means 19 secures the monolithic mounting plate 11 of the suction cup mounting platform 1 to the second mounting base 77. The ball-and-socket type swivel 73 is interlockable by means of a releasable clamp 83 for securing the second mounting base 77 after a desired rotational and angular orientation is achieved for the suction cup mounting surface 17 on the first face 13 of the mounting plate 11. The suction cup mounting device 29 is secured by vacuum to the substantially smooth and planar suction cup mounting surface 17. Thereafter, the swivel mount assembly 69 is operated in a known manner for presenting the suction cup mounting surface 17 and the suction cup mounting device 29 secured thereon in different desired rotational and angular orientations.

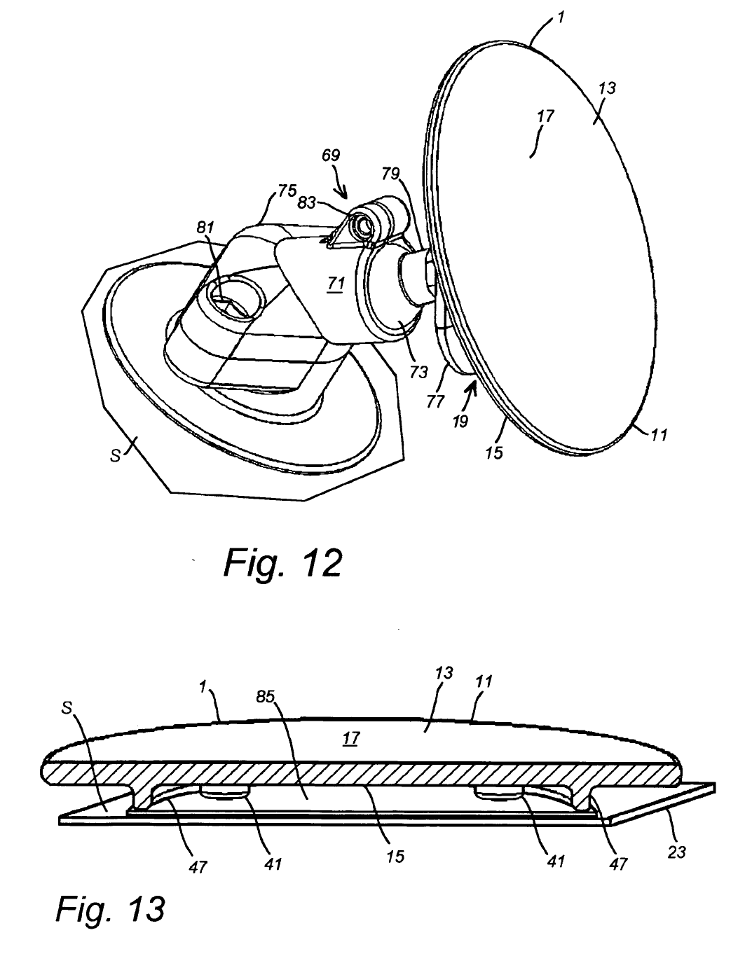

FIG. 12 illustrates the suction cup mounting platform 1 again being attached to the interlockable ball-and-socket type swivel mount assembly 69. Here the swivel mount assembly 69 is attached to the interior surface S of the vehicle by a resilient adhesive pad, commonly known as a Pressure Sensitive Adhesive or PSA 85 applied between the bottom surface of the first mounting base 75 and an interior surface S of the vehicle. Thereafter, the swivel mount assembly 69 is operated in a known manner for presenting the suction cup mounting surface 17 of the mounting plate 11 and the suction cup mounting device 29 secured thereon in different desired rotational and angular orientations.

FIG. 13 illustrates the suction cup mounting platform 1 being attached to either of the accessory vehicle mounting platform 23 or directly to an interior surface S of the vehicle, such as the dash or a console. Here, the fastening means 19 utilizes the PSA 85 in place of the plurality of screw-type fasteners 51 for fastening the second face 15 of the mounting plate 11 to either of the accessory vehicle mounting platform 23 or directly to an interior surface S of the vehicle. For example, the PSA 85 is applied between the bottom surface or second face 15 of the mounting plate 11 directly between the either or both of the bosses 41 and the stiffener structure 47 and either the accessory vehicle mounting platform 23 or an interior surface S of the vehicle. Accordingly, other structures, such as but not limited to the PSA 85, can be substituted for the screw-type fasteners 51 for providing the fastening means 19 without deviating from the scope and intent of the present invention.

When the PSA 85 is utilized as the fastening means 19 for fastening the mounting plate 11 directly to an interior surface S of the vehicle, the suction cup mounting platform 1 becomes a permanent suction cup mounting platform within the vehicle.

### Alternative Embodiments

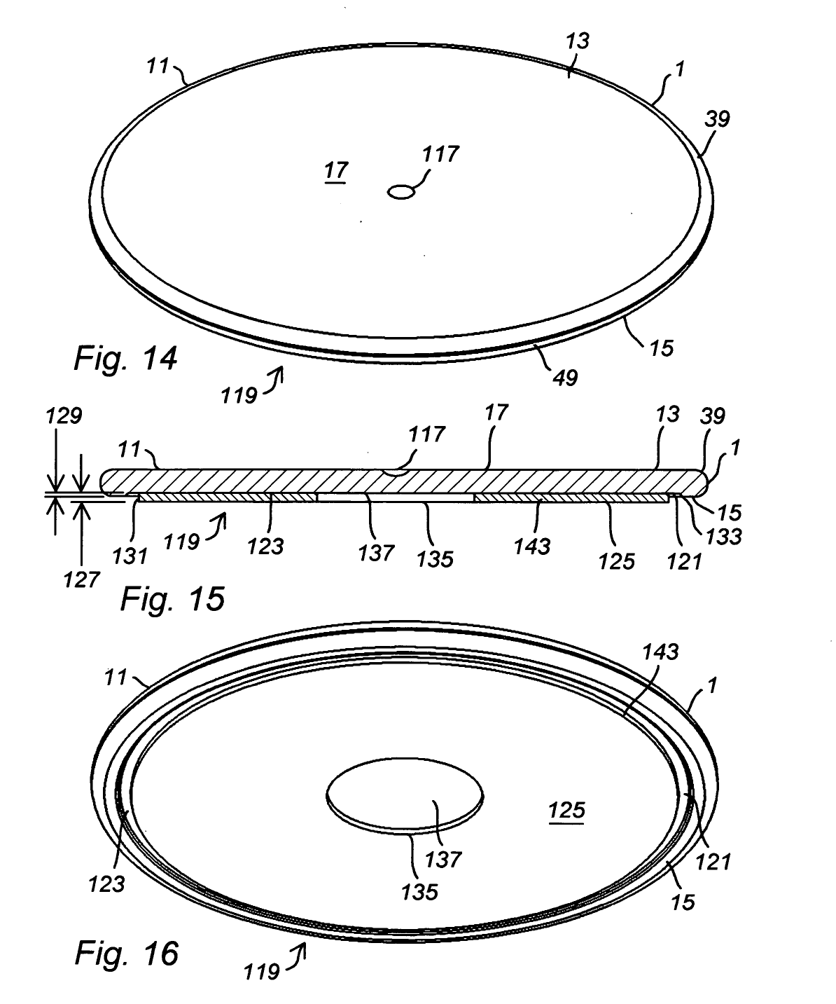

FIGS. 14, 15 and 16 are a top perspective assembly view, a side assembly view, and bottom perspective assembly view, respectively, that each show the present invention illustrated by example and without limitation as an alternative suction cup mounting platform 1 formed as the substantially monolithic mounting plate 11 of substantially uniform clarity and homogeneous transparent consistency. The substantially monolithic mounting plate 11 is formed having first and second opposing faces 13 and 15. The first face 13 is formed with the substantially smooth and planar surface 17 of a type useful as a suction cup mounting surface. The suction cup mounting surface 17 optionally covers a portion of the first face 13 less than substantially the entirety thereof The mounting plate 11 is illustrated here as being substantially round, however, the mounting plate 11 may be another shape than substantially round; for example, the mounting plate 11 may be substantially square or polygonal without deviating from the scope and intent of the present invention. The mounting surface is optionally formed with a relief or divit 117 substantially central of the mounting surface 17. The divit 117 ensures that a burr will not interfere with mounting of a suction cup mounting device 29 on the suction cup mounting surface 17. Otherwise, such a burr might be left as the result of a manufacturing process, such as machining or molding. The first and second faces 13 and 15 are optionally formed with the respective peripheral edge breaks 39 and 49 to eliminate sharp edges.

The mounting platform 1 is optionally either machined from a stock material, or else formed of an injection moldable material, such as plastic, that is substantially optically clear or transparent, whereby the mounting platform 1 virtually disappears into the target attachment surface S on which it is mounted. According to one embodiment, the mounting platform 1 is optionally formed of a substantially optically transparent polycarbonate material, which is known to be virtually unbreakable. Here, the mounting plate 11 is formed having a cross-section of at least minimum thickness as to be substantially strong and rigid enough to operate as a suction cup mounting surface.

As better illustrated in FIGS. 15 and 16, the second face 15 is assembled with a fastening means 119 for fastening to a non-planar surface.

The fastening means 119 is utilized for fastening the mounting plate 11 to any substantially planar surface, such as by example and without limitation, any substantially planar vehicle door, console or dashboard surface. The fastening means 119 is capable of fastening to a substantially rigid mounting surface, or a substantially soft and yielding mounting surface. According to one embodiment, the fastening means 119 is a pressure sensitive adhesive (PSA) 125 adhered to a bonding surface 123 of the mounting plate 11 and capable of bonding to the target attachment surface S on which the alternative suction cup mounting platform 1 is fastened. As illustrated here by example and without limitation, a flexible plastic carrier film or tape 143 is double-coated with the pressure sensitive adhesive (PSA) 125 and bonded to the bonding surface 123 of the mounting plate 11. By example and without limitation, the bonding surface 123 of the mounting plate 11 is formed on the second face 15 opposite from the planar surface 17 of the first face 13 and substantially concentric with the mounting plate 11.

Alternatively, the second face 15 is optionally formed with a shallow recess 121 opposite from the planar surface 17 of the first face 13 substantially concentric with the mounting plate 11 and only slightly smaller in diameter. The recess 121 is formed with the bonding surface 123 recessed within the back face 15 of the mounting plate 11. As illustrated here, the PSA 125 is adhered to the recessed bonding surface 123 of the mounting plate 11. As further illustrated here, the PSA 125 is thicker in extent 127 than a depth of a shallow floor portion 129 of the recess 121 beneath the second face 15 of the mounting plate 11 and opposite from the planar surface 17 of the first face 13 upon which the PSA 125 is adhered. Accordingly, a portion 131 of the PSA 125 is extended beyond a mouth 133 of the recess 121 and past the second face 15 of the mounting plate 11. Accordingly, a portion of the PSA 125 is projected past the second face 15 of the mounting plate 11 and exposed and available for adhering to the target attachment surface S.

As illustrated here by example and without limitation, the PSA 125 is configured in an annular “doughnut” shape having a substantially centered core aperture 135 that, in assembly with the mounting plate 11, substantially aligns with a center portion 137 of the second or back face 15. Accordingly, a burr can be left at the center portion 137 without interfering with the PSA 125. Such a burr might be left as the result of a manufacturing process, such as machining or molding.

A strippable protective film is optionally laid over the exposed portions of the PSA 125 to protect the adhesive from collecting dust and dirt that could reduce its bonding strength.

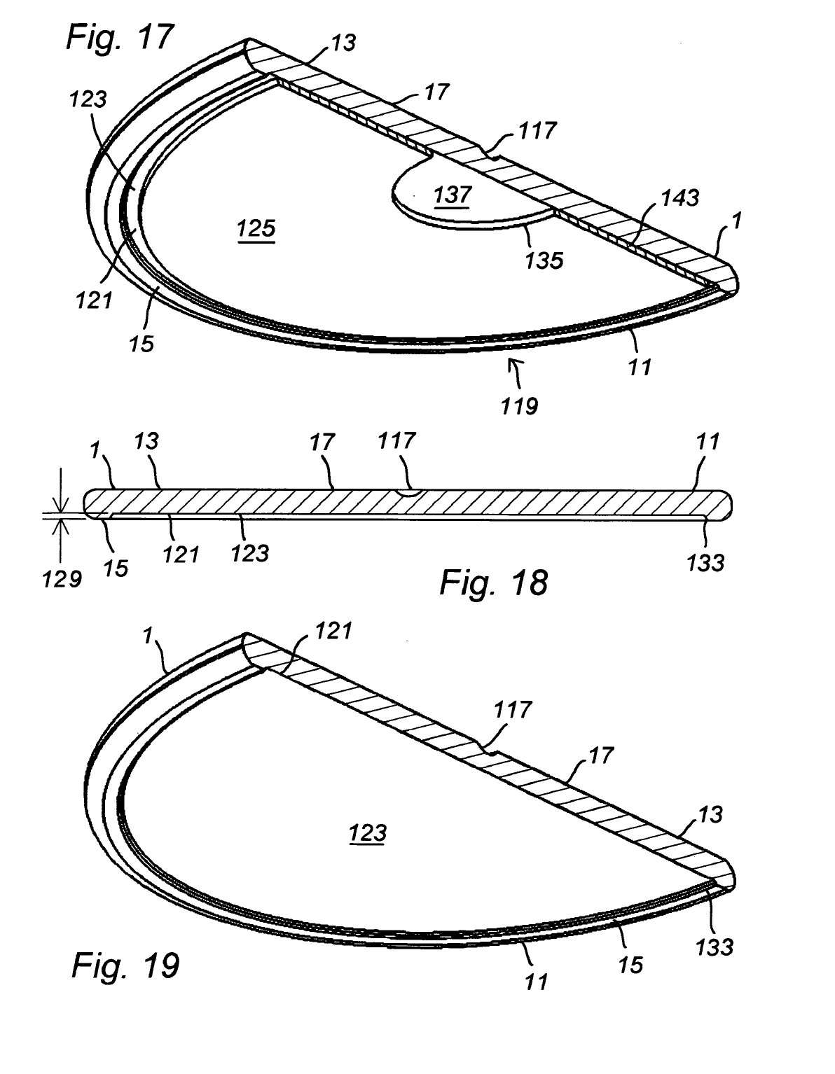

FIG. 17 is a bottom perspective view showing the alternative substantially transparent suction cup mounting platform assembly 1 in cross-section. Here, the second face 15 of the is the mounting plate 11 is formed with the optional shallow recess 121 opposite from the planar surface 17 of the first face 13 substantially concentric with the mounting plate 11 and only slightly smaller in diameter. The recess 121 is formed with the bonding surface 123 recessed within the back face 15 of the mounting plate 11. As illustrated here, the PSA 125 is adhered to the recessed bonding surface 123 of the mounting plate 11, and the thicker extent 127 of the PSA 125 causes its extended portion 131 the to be projected from the shallow depth 129 of the recess 121 beyond its mouth 133 and past the second face 15 of the mounting plate 11.

FIG. 18 is a side view showing the alternative substantially transparent suction cup mounting plate 11 in cross-section and illustrating the features described herein.

FIG. 19 is a bottom perspective view showing the alternative substantially transparent suction cup mounting plate 11 in cross-section and illustrating the features described herein.

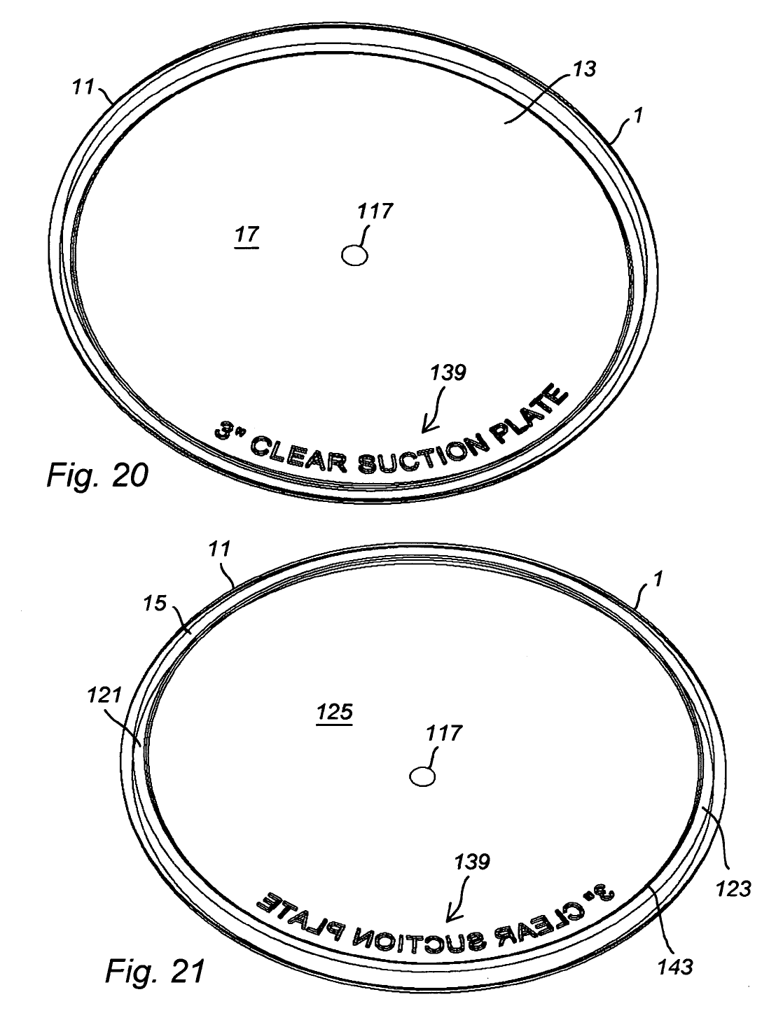

FIGS. 20 and 21 illustrate the assembly of the alternative suction cup mounting platform 1, wherein FIG. 20 is a top perspective view and FIG. 21 is a bottom perspective view. As illustrated here, the alternative suction cup mounting plate 11 and the PSA 125 bonded to the bonding surface 123 thereof are each substantially optically transparent. Accordingly, as illustrated here by example and without limitation, a descriptive marking 139 formed on either the first or second face 13, 15 is visible through both the suction cup mounting plate 11 and the PSA 125. Accordingly, the descriptive marking 139 is formed on either of the first and second faces 13, 15 of the mounting plate 11. The descriptive marking 139 is, by example and without limitation, a colored marking stamped or otherwise permanently inked on the surface of either of the first and second faces 13, 15. Else, the descriptive marking 139 is, by example and without limitation, a colorless optically transparent marking formed embossed on or relieved into the surface of either of the first and second faces 13, 15.

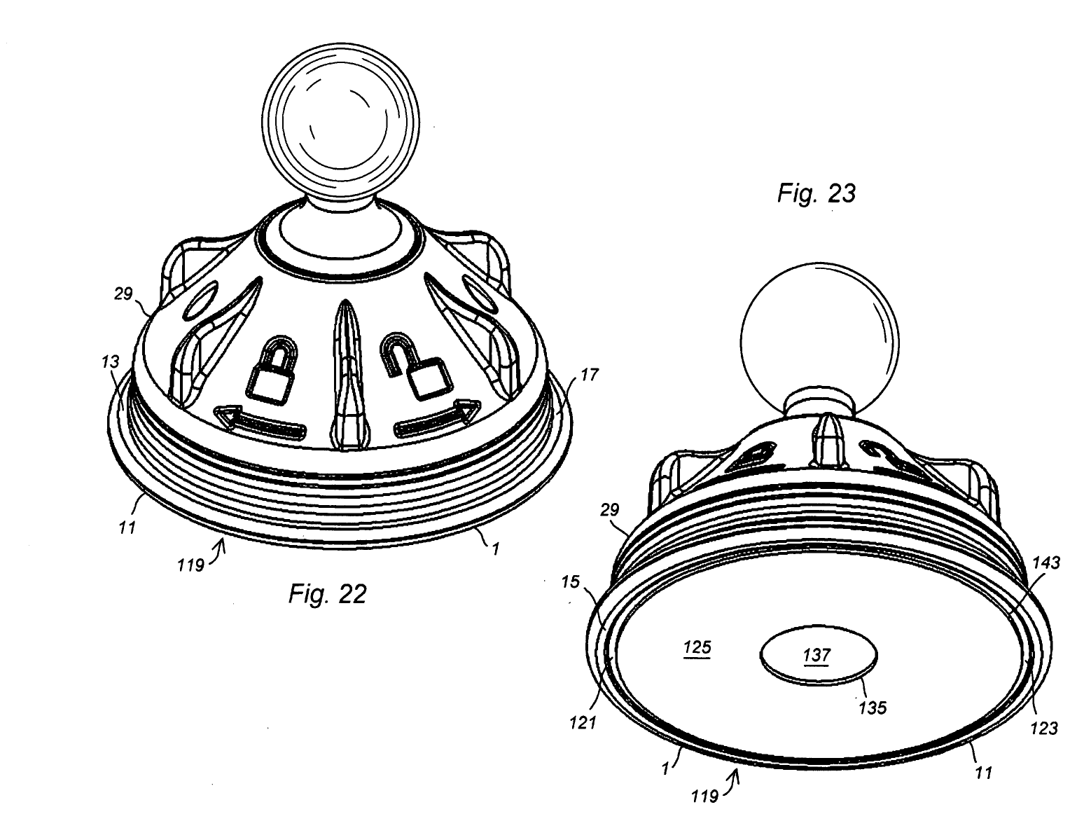

FIGS. 22 and 23 illustrate the alternative suction cup mounting platform 1 being installed on a substantially planar portion of the target attachment surface S.

In operation, if present the optional protective film is stripped away from the PSA 125, the bonding surface 123 of the mounting plate 11 with the PSA 125, including the optional double-coated plastic film or tape 143 if present, is laid against the target attachment surface S. A pressure, such as a thumb or palm pressure, is applied to the monolithic mounting plate 11, for example, at the center of the suction cup mounting surface 17 of the first face 13 thereof The applied pressure is sufficient to seat the back surface 15 of the mounting plate 11 against the attachment surface S. Additional or continued pressures, such as finger or thumb pressures, are applied to the upper face 13 of the mounting plate 11 for further effectuating adhesion of the PSA 125.

As discussed herein, the material of the alternative suction cup mounting platform 1, including the mounting plate 11, the PSA 125, and the optional film or tape 143, if present, are all optionally substantially optically clear or transparent, whereby the mounting platform 1 virtually disappears into the target attachment surface S on which it is mounted. Accordingly, when the suction cup mounting device 29 is not present thereon, the alternative suction cup mounting platform 1 does virtually nothing to mar the aesthetics of the attachment surface S on which it is mounted.

FIGS. 22 and 23 illustrate the alternative suction cup mounting platform 1 having the suction cup mounting device 29 mounted on the suction cup mounting surface 17 of the first face 13 of the optically transparent mounting plate 11.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A suction cup mounting platform, the mounting platform comprising:
a substantially rigid plate formed of a substantially optically transparent material and having first and second opposing faces;
a suction cup mounting surface formed on the first face of the plate;
a bonding surface formed on the second face of the plate; and
a substantially optically transparent bonding agent adhered to the bonding surface of the second face of the plate.

2. The mounting platform of claim 1 wherein the bonding agent further comprises a pressure sensitive adhesive adhered to the bonding surface of the second face of the plate.

3. The mounting platform of claim 2, further comprising a carrier film adhered to the bonding surface of the second face of the plate and having the pressure sensitive adhesive provided on a surface thereof opposite from the bonding surface, the carrier film being formed of a substantially optically transparent material.

4. The mounting platform of claim 3, further comprising a pressure sensitive adhesive bonded between the carrier film and the bonding surface.

5. The mounting platform of claim 4 wherein the second face of the plate further comprises a recess therein having the bonding surface formed therein, and the carrier film adhered thereto being projected therefrom outwardly of the second face of the plate.

6. The mounting platform of claim 5 wherein the material of the plate is further substantially homogeneous in consistency.

7. The mounting platform of claim 6 wherein the material of the carrier film is further substantially homogeneous in consistency.

8. A suction cup mounting platform, the mounting platform comprising:
a substantially rigid monolithic plate having substantially uniform clarity and homogeneous transparent consistency, the plate further comprising spaced apart opposing first and second faces;
a substantially smooth and planar surface formed on the first face;
a substantially smooth and planar bonding surface formed on the second face; and
a pressure sensitive adhesive of substantially uniform clarity and homogeneous transparent consistency being adhered to the bonding surface.

9. The mounting platform of claim 8, further comprising a substantially transparent carrier film double-coated with the pressure sensitive adhesive and adhered to the bonding surface.

10. The mounting platform of claim 9 wherein the carrier film further comprises a substantially uniform clarity and homogeneous transparent consistency.

11. The mounting platform of claim 10 wherein the carrier film further comprises a substantially annular shape.

12. The mounting platform of claim 10 wherein the second face of the plate further comprises a recess therein having the bonding surface formed therein, and the recess being shallower than a thickness of the carrier film adhered thereto.

13. A substantially transparent suction cup mounting platform, the mounting platform comprising:
a monolithic platform formed of a substantially optically transparent material of substantially uniform optical clarity, the monolithic platform comprising:
a substantially rigid plate portion comprising first and second opposing spaced apart faces,
a substantially smooth and planar suction cup mounting surface formed on the first face,
a substantially smooth and planar bonding surface formed on the second face and oriented facing away from the plate and radially spaced from a peripheral portion of the plate; and
a substantially optically transparent bonding agent of substantially uniform optical clarity adhered to the bonding surface.

14. The mounting platform of claim 13 wherein the bonding agent further comprises a pressure sensitive adhesive.

15. The mounting platform of claim 14 further comprising a carrier film formed of a substantially optically transparent material of substantially uniform optical clarity, the carrier film adhered to the bonding surface and having the pressure sensitive adhesive provided on a surface thereof opposite from the bonding surface.

16. The mounting platform of claim 15 wherein the carrier film is further double-coated with the pressure sensitive adhesive and adhered to the bonding surface therewith.

17. The mounting platform of claim 16, further comprising a shallow recess of a substantially uniform depth formed in the second face of the plate and having the bonding surface formed on a floor portion thereof opposite from the suction cup mounting surface formed on the first face, and the carrier film adhered thereto being of a substantially uniform thickness greater than the depth of the recess.

18. The mounting platform of claim 17 wherein the plate portion of the platform and the recess formed in the second face thereof are each formed of a substantially circular shape, and the recess further comprises a mouth opening thereinto smaller than the plate.

19. The mounting platform of claim 18 wherein the carrier film further comprises a substantially circular outer peripheral boundary sized with a diameter smaller than the mouth into the recess.

20. The mounting platform of claim 19 wherein the carrier film further comprises a substantially circular inner peripheral boundary sized with a diameter smaller than the outer peripheral boundary thereof
